(19) United States
(12) Patent Application Publication
(10) Pub. No.: US 2006/0144146 A1
(43) Pub. Date: Jul. 6, 2006

(54) Non-destructive testing of materials

(76) Inventor: Claes Hedberg, Karlskrona (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/561,520

(22) PCT Filed: Jun. 21, 2004
(86) PCT No.: PCT/SE04/00995

§ 371 Date: Mar. 15, 2006

(30) Foreign Application Priority Data
Jun. 23, 2003 (SE) 0301801-7

(51) Int. Cl. G01N 29/04; G01N 29/36

(52) U.S. Cl. 73/579; 73/602; 73/625

(57) ABSTRACT

In a method of localising damages or defects in objects or in materials a standing wave is generated within the object (6) or in the material to be tested. This standing wave is substantially limited to a small area in the object or the material, between a vibration surface and another surface (8) in the object or in the material in order to detect damages or defects within said area of the object or the material from readings obtained when measuring on the standing wave and by using Slow Dynamics. A corresponding arrangement includes a signal source (2) which is connected to a transmitter (4) for generating a resonant sound wave within the object (6) or the material. A receiver (4) for receiving a measurement signal from the object or the material is connected to a measurement signal processing and analysing apparatus (10). The transmitter is adapted to generate the sound wave substantially in a small area in the object or the material, and the measurement signal processing and analysing apparatus is adapted to localise damages or defects in the object or in the material by using Slow Dynamics.

The present invention relates to a method of localising damages or defects in objects or materials wherein a standing wave is generated within the object or material in order to detect damages or defects within an area of said object or said material by virtue of a reading obtained when measuring on the standing wave. The invention also relates to a localising arrangement that includes a signal source which is connected to a transmitter for generating a resonant sound wave within the object or within the material, and a receiver for receiving a measurement signal from the object or from the material connected to an apparatus for processing and analysing said signal.

It is known to use signal wave fields for detecting defects or damages in objects or materials. For example, according to U.S. Pat. No. 4,166,393 a type of resonance excitation is used to this end, according to U.S. Pat. No. 4,823,601 vibrations are created and measured with the aid of a laser, according to DE 38 42 061, a comparison is made between resonance frequencies in damaged and undamaged work pieces, U.S. Pat. No. 5,408,305 describes a technique in which the mode configuration on the surface of the object is analysed in response to resonant oscillations, and DE 198 24 402 describes the processing of vibration data measured from work pieces and components. GB 1 184 333 describes a technique for detecting and localising construction defects, wherein a standing wave is generated in the tested construction. A defect located in the propagation path of the standing wave will be manifested by variations in the electric signal that feeds the acoustic signal source.

The object of the present invention is to provide an improved technique for detecting damages or defects in objects or materials and for enabling such damages or defects to be localised.

This object is achieved with a method and an arrangement of the kind defined in the introductory portion and having the respective characterising clauses of claim 1 and claim 4.

The technique proposed in accordance with the present invention may be used conveniently in respect of extended structures, for instance thin metal sheeting, piping, etc. A transmitter having a frequency and a diameter adapted to the geometry of the object and the properties of the material causes the object or the material to vibrate so as to generate a standing wave within the object between the vibration surface, e.g. the transmitter, and another surface in the object. When parameters are chosen correctly, the standing wave will be restricted essentially to a small area, e.g. between the transmitter and an opposing wall in the structure or the object. This standing wave is used to detect damages or defects in the object or material by use of Slow Dynamics, in other words through the agency of changes in the material properties of an object or a structure caused by an external influence, such as temperature changes, impact stresses, pressure changes or ultrasound influences, c.f. WO 02/079775. Because of the geometrical limitation of the standing wave, only damages or defects located within said area will result in significant readings in a measuring process.

The technique according to the present invention can be used beneficially with non-linear methods in which the standing wave constitutes the high frequency in, for instance, Nonlinear Wave Modulation Spectroscopy, where the standing wave is mixed with a low frequency signal that gives a sideband, or together with Slow Dynamics.

According to one beneficial embodiment of the inventive arrangement, the transmitter includes a concave transmitter element. This enables the standing wave to be concentrated so as to obtain an acoustic field that has an amplitude which is several times greater than the amplitude obtained with a flat transmitter element.

According to another beneficial embodiment of the inventive arrangement, the transmitter includes several transmitter elements. This also enables the standing wave to be concentrated, and also enables the acoustic field to be controlled in different directions by means of phase control.

According to further beneficial embodiments of the inventive arrangement, the transmitter includes a transmitting element that forms part of the object or material to be tested. The transmitter element may also be provided with additional material of a given thickness, so that a standing wave can be generated with respect to the combined thickness of the transmitter element and the test object and therewith fulfil resonance demands. This will thus ensure that the resonance demands are fulfilled in the area influenced by the incoming wave, but not in the area outside the first mentioned area.

According to other beneficial embodiments of the inventive arrangement, the receiver includes a plurality of receiver elements, alternatively at least one piezo-electric sensor or a laser sensor. The presence of several receiver elements improves reception and also achieves better localisation of detected damages or defects. The use of separate sensors, such as piezo-sensors or laser sensors, enables the acoustic field to also be read on one side of the transmitter element or on other surfaces of the object, for instance on the opposite side of a metal sheet.

According to yet another beneficial embodiment of the inventive arrangement, the transmitter and the receiver can be moved across the object or material to be tested, and the signal source includes an automatic frequency control facility with which the frequency can be changed so as to retain resonance as the transmitter and the receiver are moved. For instance, if a transmitter and a receiver are moved over the surface of an object or of a material, it is possible for the thickness of the object or the material to change and therewith change the resonance frequency of the chosen mode. It is then necessary to change the transmitter frequency correspondingly.

In order to limit the standing wave to a small area, it is essential that the radiation angle of the signal is as small as possible, meaning that the spread of energy will be small. According to another advantageous embodiment of the arrangement according to the invention the radius of the transmitter and the frequency of signal source are therefore adapted to give the transmitter output signal a small beam angle.

A contactless technique is desirable, or necessary, in the case of many applications of acoustic non destructive testing methods, such as linear and non-linear ultrasound methods for instance. According to further beneficial embodiments of the inventive arrangement, the receiver therefore includes at least one laser sensor or at least one microphone for contactless reception of the measurement signal from the object or the material. The contactless transfer of the low frequency part of the signal can, for instance, be achieved with the aid of an air pistol although the transfer of the high frequency part of said signal is more difficult to achieve, due to the large impedance difference between transmitter and air and between air and transmitter. According to still another beneficial embodiment of the inventive arrangement, the transmitter is, for this reason, adapted to the object or to the material for the contactless transfer of sound energy thereto, so as to create an open resonator between transmitter and object or material. Such a resonator recovers the energy in the oscillations and collects said energy by utilising existing modes in the object or the material. The air present between the object to which the acoustic energy shall be transferred and the transmitter thus also have modes. The use of standing waves in air also results in a multiple increase in the wave amplitude on the passive side of the resonator. The amount of energy transferred to the object will be many times the energy transferred when the object constitutes the passive side of the resonator than when resonance is not used. This technique can be used both in respect of linear and non-linear methods.

According to another beneficial embodiment of the inventive arrangement, the transmitter includes a parametric transmitter with disappearing sound. This further enhances the possibility of exciting solely a given area in the object or in the material; c.f. Swedish patent application 0104201-9.

The invention will now be described in more detail with reference to exemplifying embodiments thereof and also with reference to the accompanying drawings, in which

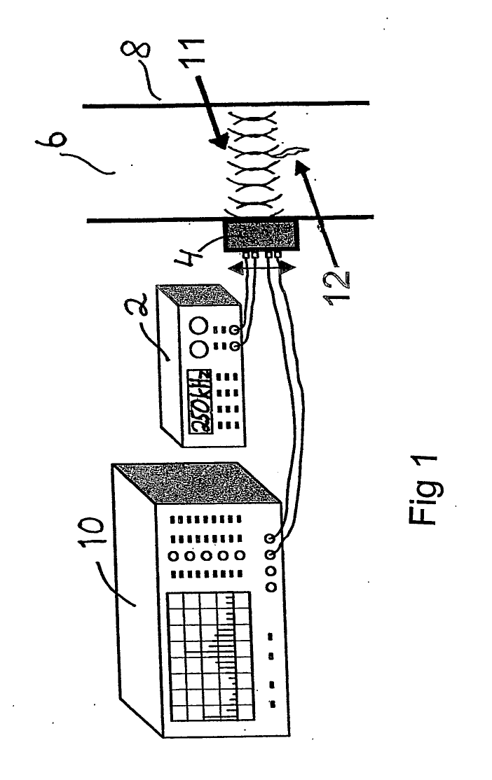

FIG. 1 illustrates a first embodiment of an arrangement according to the invention,

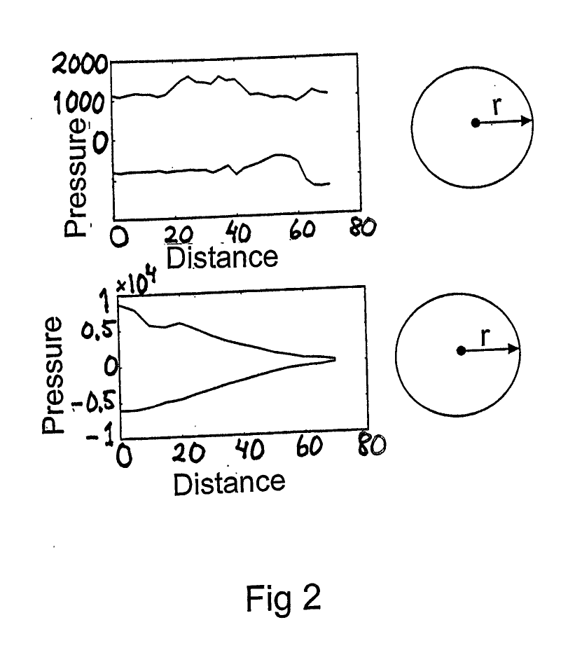

FIG. 2 illustrates the effect achieved with transmitter elements of mutually different design;

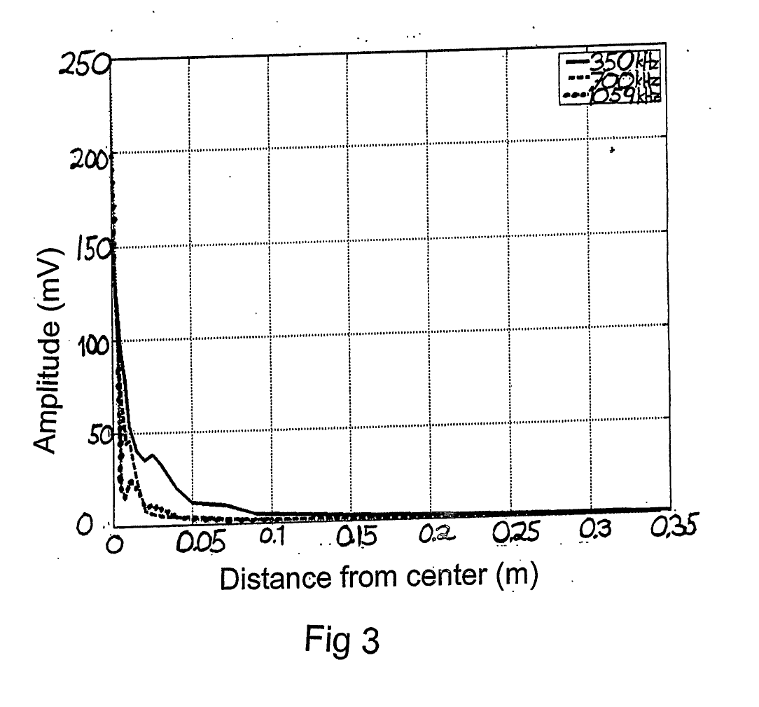

FIG. 3 illustrates the results of experiments carried out on a Plexiglas sheet;

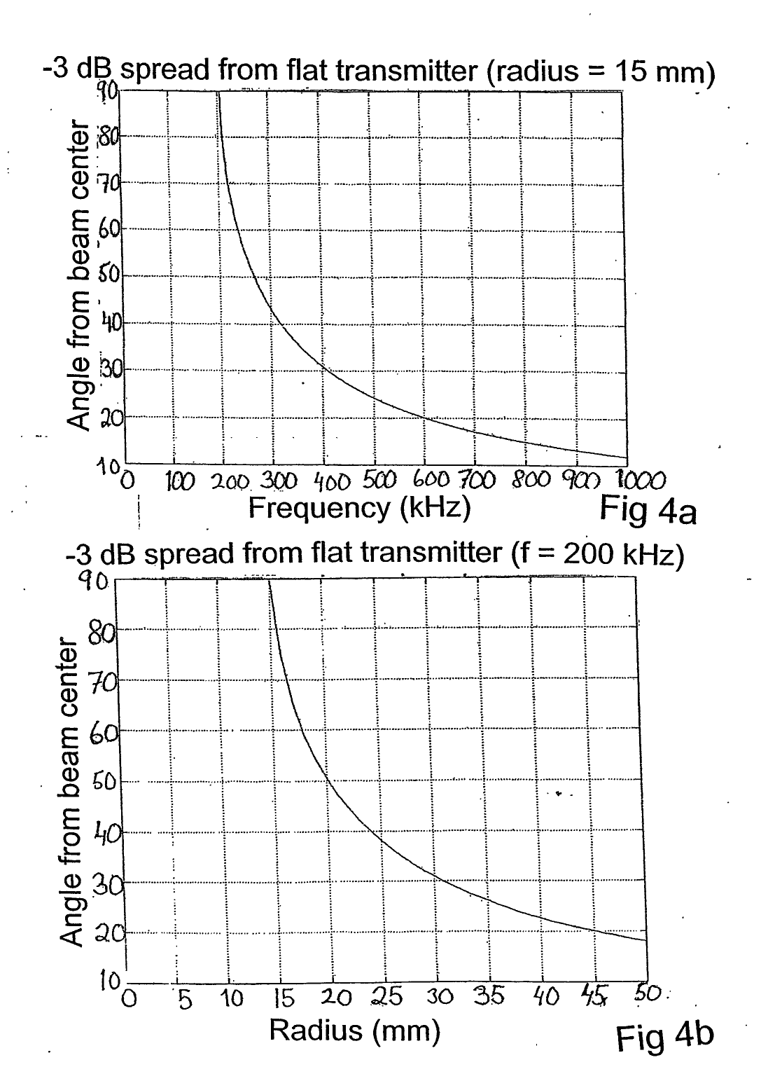

FIG. 4 illustrates examples of the variation in beam angle as a function of frequency and transmitter radius;

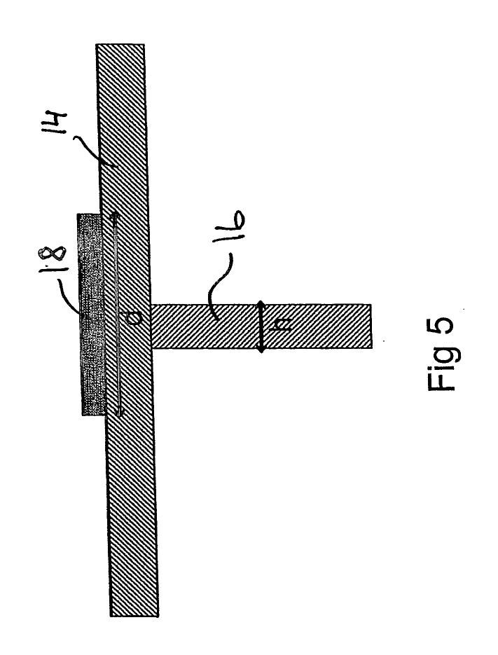

FIG. 5 illustrates application of the invention in respect of an object of particular structure;

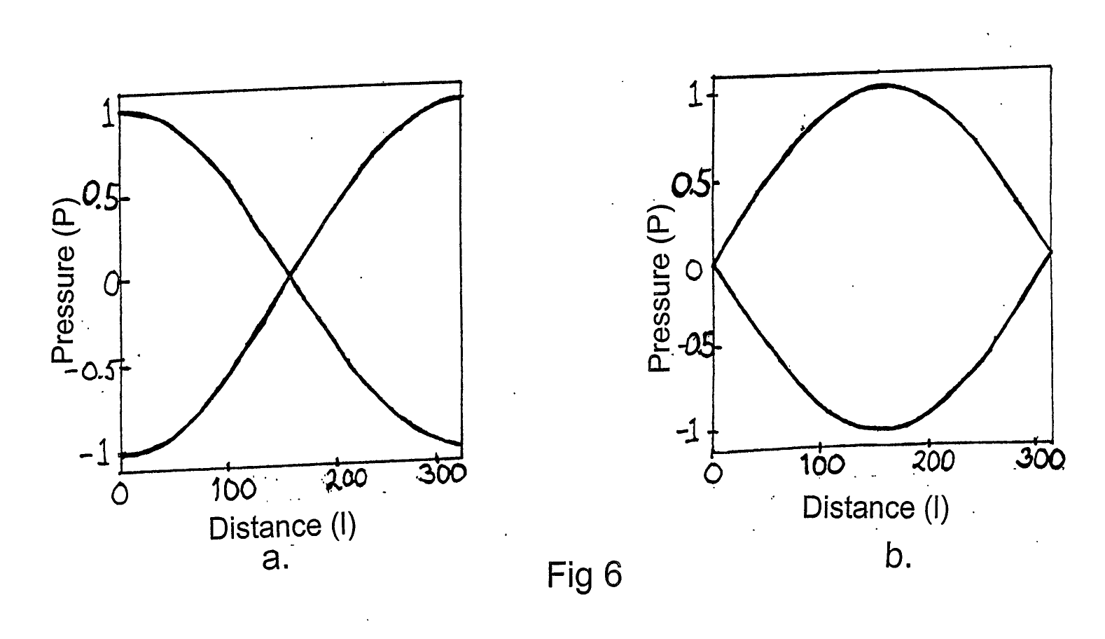

FIG. 6 illustrates pressure distribution in respect of different types of resonators;

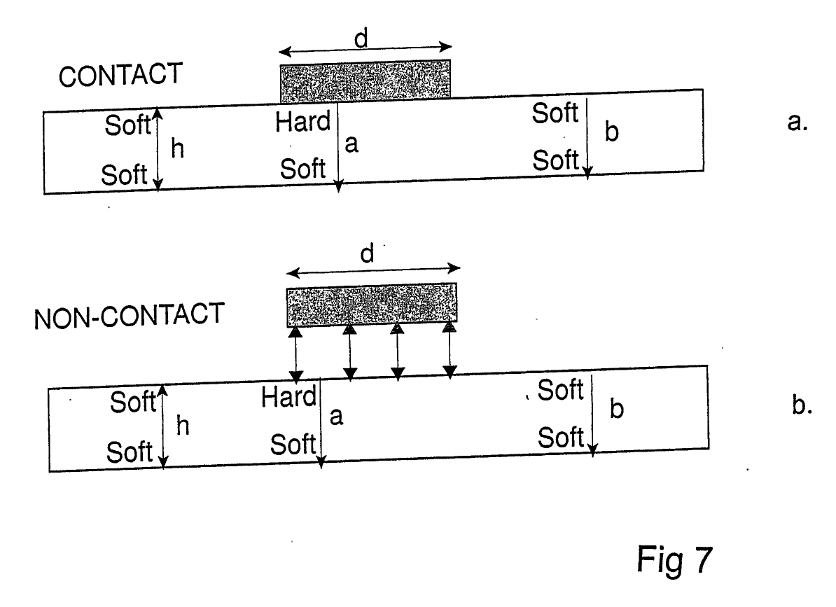

FIG. 7 illustrates examples for obtaining a limited wave field;

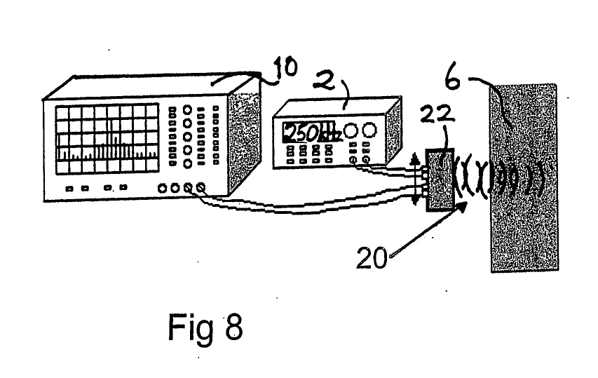

FIG. 8 illustrates a second embodiment of the an arrangement according to the invention;

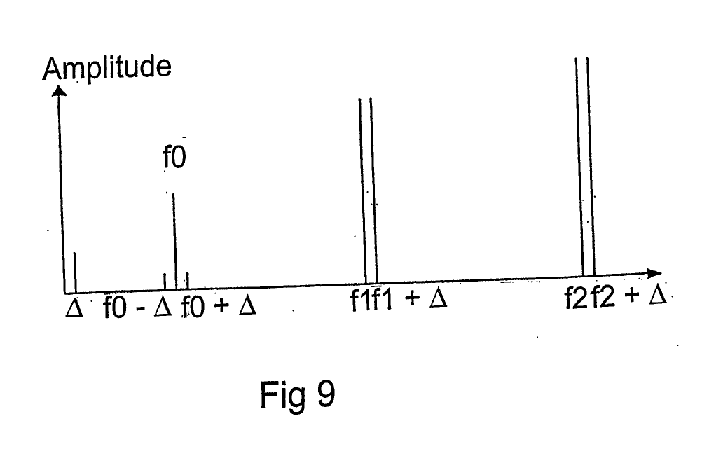

FIG. 9 shows an example of the relative positions of the frequencies in respect of conceptual amplitudes, when using the disappearing sound technique;

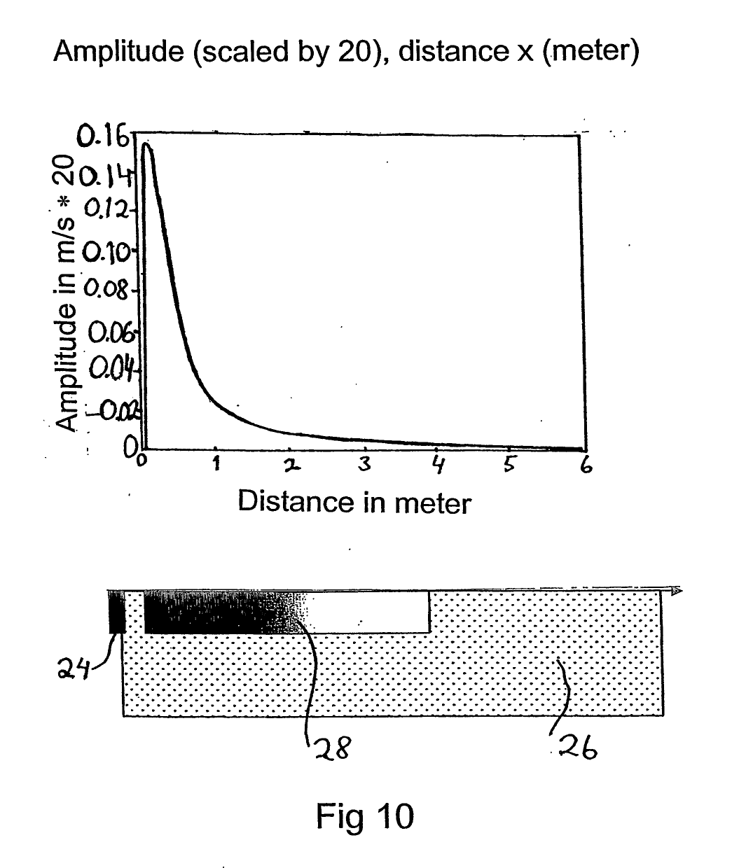

FIG. 10 illustrates further conditions in respect of so-called disappearing sound; and

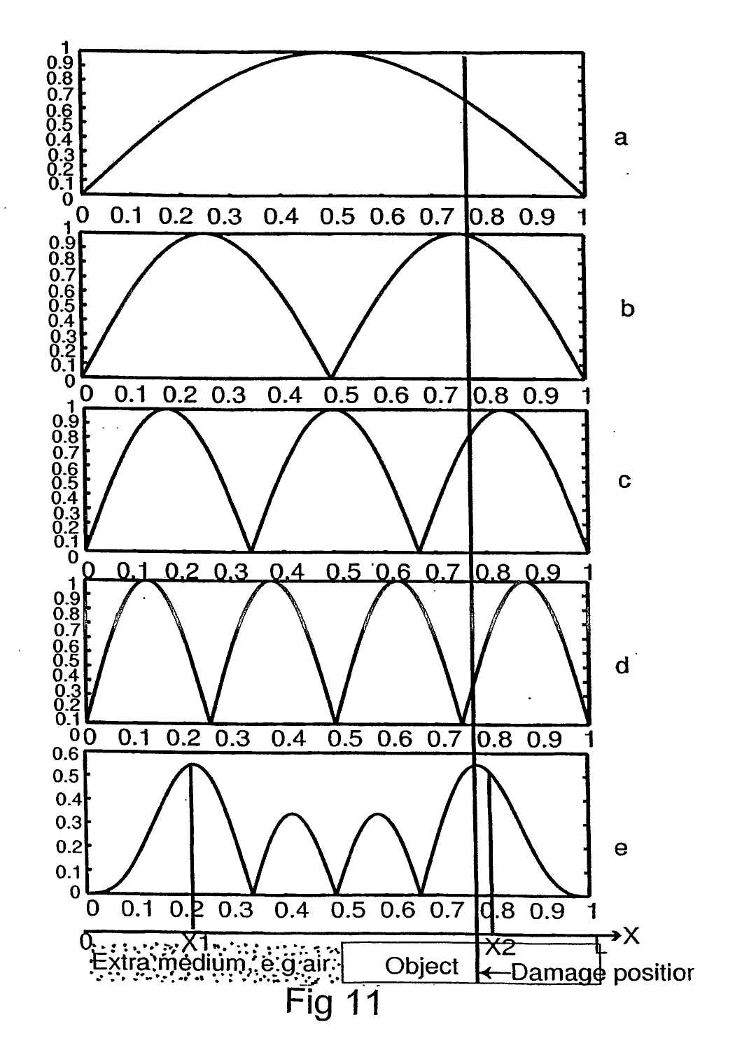

FIG. 11 is a damage position indicating curve obtained by excitation of successively different modes of oscillation in the tested object or the tested material.

Shown in FIG. 1 is a first embodiment of inventive an arrangement that includes a signal source in the form of a signal generator 2 which functions to generate a signal that is sent to the transmitter 4. The transmitter 4 creates on the object 6 vibrations whose frequency and diameter are adapted to the geometry of the object and to the properties of the material, so as to form a standing wave within the object, between the vibration surface, i.e. the transmitter 4, and an opposing surface 8 of the object 6. In the case of the FIG. 1 embodiment, transmitter and receiver are arranged in one and the same unit 4 and the receiver element is connected to a signal-detecting oscilloscope 10.

When parameters are chosen correctly, the standing wave, illustrated with curved wave parts 11 within the object 6 in FIG. 1, will be limited essentially to a small area, namely the area between the transmitter 4 and the opposing wall 8 in the object. As a result of the geometrical limitation of the standing wave, only damage or defects, such as the crack 12, will give readings of any significance in the measuring process.

The transmitter element and the receiver element are conveniently movable over the surface of the object 6. In this regard, the signal generator 2 is beneficially equipped with automatic frequency control so as to lie constantly in resonance, even when the conditions are changed as the transmitter element and the receiver element 4 are moved across the surface, for instance as a result of a change in the thickness of the object so as to change the resonance frequency for the mode chosen.

The transceiver element 4 may have one of a number of different designs or configurations. For example, the transmitter may include a planar or a concave transmitter element, or of several small elements. In the case of a concave transmitter, the standing wave will be concentrated more to the centre of the object. This is illustrated in FIG. 2, in which the pressure conditions in respect of a planar transmitter in open resonance are compared with a concave transmitter. Thus, the pressure is shown at the top of FIG. 2 as the function of the radius in an open resonator having two planar plates or sheets, while the pressure is shown at the bottom of the figure with a planar and a concave plate. It will be seen from the figure that the acoustic field obtained with the concave transmitter element is more concentrated and that the amplitude in the centre of the object is roughly five times higher than in the case of a planar plate. In addition to the geometric energy concentration, this also means that the concave reflection causes the wave to be more gentle in the time plan, in the absence of impacts, so that less energy will be dissipated in the so-called non-linear damping or attenuation of the wave.

The standing wave can also be concentrated more towards the centre of the object with a transmitter that includes several small elements, and it is also possible to steer the sound field in different directions with the aid of such a transmitter.

The receiver may comprise a single element or, alternatively, several elements for better reception and better localisation. It is also possible to read the sound field at the side of the transmitter element with the aid of separate sensors for instance, such as piezoelectric sensors or laser sensors, or on other surfaces of the object, for instance on the opposite side of a plate-like object.

The results of experiments carried out on a large sheet of Plexiglas with the aid of a transmitter 30 mm in diameter are shown in FIG. 3, said figure showing measured pressure amplitudes as a function of the radius of the first three transversely standing waves. The Plexiglas sheet had a thickness of 5 mm. It will be seen that the sound field was limited to an area of less than 10 cm from the transmitter, with the totally dominating part of the energy concentrated to a radius of 2 cm in respect of the highest frequency.

This limited sound field enables the technique to be used in the novel highly sensitive non-linear methods for the detection of micro-cracks or macro-cracks, for instance for detecting the beginning of fatigue when carrying out need-based maintenance or when checking components in the manufacturing industry. This limited sound field can then constitute the resonant signal when using different applications of Slow Dynamics for non destructive testing, c.f. WO/02079775.

It will be noted that the frequencies used in the non-linear methods are much lower than the frequencies used in typical linear methods, since the non-linear methods are based on a change in the material parameters and can therewith be used in respect of large objects or in respect of objects that have a high degree of damping—the higher the frequency, the higher the damping. Linear methods often use such small wavelengths as to enable the sound waves to “see” the cracks. Consequently, the use of the localised sound field is not equally as beneficial for all linear acoustic methods of material testing, although the principle is, of course, also usable for different linear measuring processes.

It is difficult to give generally the precise magnitude of all parameters that must be taken into account in each individual case, since the parameters will be relatively many in number and will depend, for instance, on material properties, object sizes, object geometries, transmitter sizes, transmitter powers, and surface smoothness.

FIG. 4a illustrates the beam angle of the signal as a function of the frequency of a planar transmitter having a radius of 15 mm, while FIG. 4b illustrates the beam angle as a function of the radius of the transmitter for a fixed frequency of 200 kHz. A small beam angle is beneficial, since the energy will not then be spread but will be held gathered close to the transmitter.

FIG. 5 shows an example of a structure that includes a wall 14 and a beam 16 which lies behind the wall. In this case, the area in front of the rearwardly lying structure will also be excited if a large part of the exciting area of the sound source 18 lies outside the structure. The resonance at the planar parts outside the area of the beam 16 will then also excite the inwardly lying area which will obtain a significant sound field, similar to the area at the side of an open resonator. This sound field will not, of course, be as large as if the beam 16 was not present.

In many applications of acoustic non-destructive testing methods it is desirable and necessary to use contactless methods. An open resonator can be used conceivably to improve the energy transfer of high frequency signal parts.

The Q-factor is a resonator quality factor; the higher the Q-factor the better. In B. Enflo and C. Hedberg, “Theory of non-linear acoustics in fluids”, Kluwer Academic Publishers, 2002, ISBN 1-4020-0572-5, picture 8.4 page 429, there is give an example of the ability of a resonator to increase the amplitude of a wave. In this example, there is excited a resonator with an amplitude of 0.002 and a wave field having an amplitude of about 1 is obtained. The Q-factor is then 1/0.002=500.

A resonator preserves the energy in oscillations and collects the oscillations by utilising existing modes in structures. The air present between the object to which acoustic energy shall be transferred and the transmitter also have modes. This is generally known, and standing waves are used to levitate small objects in air, among other things. With this concept, there is obtained a multiple increase in the wave amplitude on the passive side of the resonator, as illustrated in FIG. 6a which shows the pressure distribution for the first mode of a resonator having hard surfaces. If the passive side of the resonator is chosen as our object, the amount of energy entering the object will be far greater than if resonance was not used. This can be applied in both linear and non-linear methods. The first resonance mode within the object could possibly have the form shown in FIG. 6b, since the object is “hard” surrounded by “soft” air or some other fluid.

There exist, of course, variants of different hard and soft mixtures and of different degrees of hard and soft. For example, the side influenced by an incoming sound wave can appear to be hard from within the object due to the pressure exerted by the sound wave, so that we obtain a hard reflection at this location and a soft reflection on the other side.

The reason why a limited wave field is obtained in respect of an area within the object concerned is thus because the conditions for resonance are fulfilled locally in this area, but not externally thereof. An example is shown in FIG. 7 in which the sound wave causes the edge of one side to appear to be hard locally, at least to a certain degree, either as result of direct influence of the transmitter, FIG. 7a, or as a result of a contactless influence, FIG. 7b. This means that when resonance criteria are fulfilled in respect of an area influenced by the incoming wave, the criteria will normally not be fulfilled externally of this area. Similarly, the resonance criteria can be changed by adding a material of extra thickness to the transmitter, or by allowing the transmitter to be included in the resonant system.

It can be mentioned in parenthesis that the transmitter can be allowed, conversely, to operate at a frequency at which the antiresonance condition for the area concerned is fulfilled, therewith obtaining a low amplitude in this area. The amplitude obtained externally of this area will then normally be greater than the amplitude obtained inwardly thereof. This option, however, has no direct application with the present invention.

Resonance occurs when the distance between transmitter and object, the velocity of sound in the medium between object and transmitter, e.g. air, and the frequency and diameter of the transmitter fulfil the conditions that apply to an open resonator.

FIG. 8 illustrates a second embodiment of an arrangement according to the invention, said arrangement including an open 20 resonator transmitter 22 for contactless non-destructive testing of material. Those components of respective embodiments in FIG. 1 and FIG. 8 that find correspondence with one another have been identified by the same reference signs. Thus, the embodiment according to FIG. 8 uses the resonance between transmitter 22 and object 6. Resonance may, of course, also exist within the object 6 at the same time. The resonance criteria can be set, by varying frequency and distance between transmitter 22 and object 6.

According to one alternative it is possible with the use of a parametric transmitter with disappearing sound to excite a given area by means of a frequency difference, for the purpose of localising cracks, for example.

The designation frequency difference is used below as an example of the frequency of interest that is first created and then extinguished by higher frequencies. This need not be a frequency difference, but may be another frequency concerning other sorts of modulations, for instance frequency modulations or amplitude modulations of the signal. Notwithstanding, we designate the locally occurring frequency below as the ” frequency difference”, since the example described hereinafter with reference to FIG. 9 utilises precisely the frequency difference, c.f. Swedish patent publication 01042201-9.

A first non-linearity that creates the frequency difference resides in the inherent non-linearity of the material, which is assumed to be relatively low. This means that the signals that shall create f2 and f2+Δ and extinguish f1 and f1+Δ, the frequency difference, must be strong.

The second non-linearity of significance in this context resides in the non-linearity that indicates the presence of cracks. Because cracks are pronouncedly non-linear, this non-linearity is often several magnitudes greater than the natural non-linearity of the material, wherewith the strength of the signals, Δ and f0, that shall form sidebands in the presence of cracks etc. need not be so great.

For the detection of cracks, there are sent signals of high amplitude and two high frequencies, f2 and f2+Δ, which co-act non-linearly due to the inherent non-linearity of the medium and give parametrically a frequency difference Δ. The amplitude of this frequency is much smaller than the amplitude of the signals having the frequencies f2 and f2+Δ.

There is moreover sent a signal having the frequency f0, which is possibly in resonance. This frequency corresponds to the high resonance frequency, whereas the low frequency signal corresponds to the frequency Δ in this case. It can therefore create a sideband around the frequency f0, i.e. a sideband of f0+Δ and of f0−Δ around f0.

The frequency Δ is then extinguished by two further signals of high amplitude and high frequencies f1 and f1+Δ which form antisound to the sound formed by the signals of frequencies f2 and f2+Δ.

This enables a sideband to be created within the region in which the frequency difference Δ is present. We can thus localise the damage or defect to this region. Of course, it can be read outside the region itself.

FIG. 9 is a schematic illustration of the relative positions of the frequencies having conceptual amplitudes, as given in the aforedescribed exemplifying embodiment.

Parametric sound will automatically have a small beam angle and is thus localised in a purely radial direction. Moreover, longitudinal propagation of the sound can be limited, as illustrated in FIG. 10. There is shown at the top of the figure a one-dimensional image of the amplitude of the aforesaid frequency difference of the disappearing sound as a function of the distance. The frequency is then created and extinguished.

The lower part of FIG. 10 shows a transmitter 24 for transmitting disappearing sound in an object 26, wherewith the approximate region of the disappearing sound is illustrated conceptually by the grey-coloured area 28 in the figure.

The direction of the beam can be controlled with the aid of a phase controlled transmitter that includes several transmitter elements and the location of the frequency difference can be controlled by different frequency selection. This embodiment thus enables several different areas to be tested and thus enables different defective or damaged areas to be tested and localised without moving the transmitter.

It will also be noted that different modes give different nodes for the standing wave and the resultant non-linear response will depend on the extent to which the standing wave is influenced by the damage or defect in the object, and vice versa. The use of several different modes that investigate different parts of the object enables the non-linear responses to be weighted so as to provide a picture of where the damage or defect can be found. Those methods known hitherto give a degree of ambiguity due to the fact that the modes and the functions are symmetrical, or are ambiguous for some other reason, see Didenkulov et al, “Modulation modal method for crack location”, Proceedings of Tenth international Congress on Sound and Vibration, Jul. 7-10, 2003, Stockholm, and Didenkulov et al, “Nonlinear acoustic technique of crack location” in W. Lauterborn and T. Kurz ed. “Nonlinear acoustic at the turn of the Millenium”, Melville, N.Y., 2000, pp. 329-332.

This ambiguity disappears when a part of the tested unit or the tested medium is allowed to consist of a material which is known to contain no defects or damages. This material may, for instance, consist of the air used in a contactless apparatus, such as described above. Alternatively, a material part may be used to give a better localised wave field, as described above.

FIG. 11 illustrates examples of different oscillation modes of an object that has a defect or damage located at position X2. FIG. 11a illustrates a first mode—non-linear response ε₁, FIG. 11b illustrates a second mode—non-linear response ε₂, FIG. 11c illustrates a third mode—non-linear response ε₃, and FIG. 11d illustrates a fourth mode—non-linear response ε₄.

Different non-linear responses ε_{N} can be obtained, by exciting one mode at a time. The mode forms can be weighted with these responses in various ways, which are well known to the person skilled in the art and will not therefore be described in more detail here, so as to obtain a damage position indicating curve such as that shown in FIG. 11e. FIG. 11e thus shows a damage position indicating curve which is obtained from modes weighted with non-linear responses, said curve having two maxima at X1 and X2.

If, in the case illustrated in FIG. 11, an object was damage free from O to L it would have been impossible to determine whether the damage was located at position X1 or at position X2. When a damage free medium is positioned in front of the object being tested and constitutes part of the tested unit consisting of said object and a damage free medium it will be known that the damage exists at X2, said damage free medium being air in the FIG. 11 illustration, although may also consist of a solid or a liquid medium.

It will be noted that the image is schematic. In the case of different materials, the wave form will either be extended or compressed in the X-direction of the different media, due to the fact that the wave velocities differ. In the case of the example shown in FIG. 11, the sound velocity is the same in both object and air. This has no principle significance, however, but is solely due to length scaling.

1. A method of localising damages or defects in objects or materials, wherein a standing sound wave is generated within the object or the material in order to detect damages or defects within an area of the object or the material by virtue of a reading obtained when measuring on the standing wave, comprising limiting the standing wave substantially to a small area in the object or in the material, between a vibration surface and another surface in the object or the material, and using said standing wave for detecting damages in the object or in the material by the use of Slow Dynamics.

2. A method according to claim 1, comprising sending into the object or into the material two signals of slightly different high frequencies, such as to generate a frequency difference of low frequency value as a result of the non-linearity of the object or of the material, which low frequency signal creates sidebands to a signal of a third frequency, said third frequency signal being delivered to the object or, to the material for the purpose of detecting damages or a defect in said object or in said material from the occurrence of said sideband.

3. A method according to claim 1 in which there is tested a unit which comprises said object or said material and a damage-free or faultless medium, comprising exciting several different oscillation modes in said unit, and weighting non-linear responses such as to form a damage position indicating curve that indicates the position of the damage or defect.

4. An arrangement for localising damages or defects in objects or in materials; wherein the arrangement includes a signal source which is connected to a transmitter for generating a resonant sound wave within the object or the material, and a receiver for receiving a measurement signal from the object or the material connected to a measurement signal processing and analysing apparatus, wherein the transmitter is adapted to generate the sound wave substantially in a small area in the object or the material, and in that the measurement signal processing and analysing apparatus is adapted to detect damage or defects in the object or in the material by the use of Slow Dynamics.

5. An arrangement according to claim 4, wherein the transmitter is adapted with respect to said object or said material for the contactless transfer of sound energy to the object or the material, so as to create an open resonator between transmitter and object or transmitter and material.

6. An arrangement according to claim 4, wherein the transmitter includes a planar transmitter element.

7. An arrangement according to claim 4, wherein the transmitter includes a concave transmitter element.

8. An arrangement according to claim 4, wherein the transmitter includes a plurality of transmitter elements.

9. An arrangement according to claim 8, wherein the transmitter containing said plurality of transmitter elements is phase controlled for steering the direction of the signal beam.

10. An arrangement according to wherein the transmitter includes a transmitter element which consists of part of the object or the material.

11. An arrangement according to claim 4, wherein the transmitter element includes additional material of pre-determined thickness so as to fulfill the conditions for resonance in that area or region of the object or the material where damage in the object or the material is intended to be localised.

12. An arrangement according to claim 11, wherein the transmitter element includes a material that has generally the same acoustic impedance as the object or the material, and said transmitter element is intended to be brought into contact with the object or the material in which damage shall be localised.

13. An arrangement according to claim 4, wherein the receiver includes a plurality of receiver elements.

14. An arrangement according to claim 4, wherein the receiver includes at least one piezoelectric sensor.

15. An arrangement according to claim 4, wherein transmitter and receiver are disposed in one and the same unit.

16. An arrangement according to claim 4, wherein said measurement signal processing and analysing apparatus includes an oscilloscope.

17. An arrangement according to claim 4, wherein said signal source and said measurement signal processing and analysing apparatus are realised with the aid of a computer.

18. An arrangement according to claim 4, wherein the transmitter and the receiver can be moved over, or across, the object or the material and the signal source includes an automatic frequency control facility which functions to change the frequency such as to retain resonance as the transmitter and receiver are moved.

19. An arrangement according to claim 4, wherein the radius of the transmitter and the frequency of the signal source are adapted to give the signal from the transmitter a small beam angle.

20. An arrangement according to claim 4, wherein the receiver includes at least one laser sensor for contactless reception of the measurement signal from the object or the material.

21. An arrangement according to claim 4, wherein the receiver includes at least one microphone for contactless reception of the measurement signal from the object or the material.

22. An arrangement according to claim 4, wherein the transmitter includes a parametric transmitter having disappearing sound.
